(19) United States
(12) Patent Application Publication
(10) Pub. No.: US 2008/0183393 A1
(43) Pub. Date: Jul. 31, 2008

(54) Method and system for forecasting earthquakes

(76) Inventors: John B. Rundle, Davis, CA (US); James R. Holliday, Folsom, CA (US); Kristy F. Tiampo, London (CA)

Correspondence Address: PARK, VAUGHAN & FLEMING LLP, 2820 FIFTH STREET, DAVIS, CA, 95618-7759, US

(21) Appl. No.: 12/011,374

(22) Filed: Jan. 24, 2008

Related U.S. Application Data
(60) Provisional application No. 60/897,788, filed on Jan. 25, 2007.

(51) Int. Cl. G01V 1/28

(52) U.S. Cl. 702/15

(57) ABSTRACT

One embodiment of the present invention provides a system that forecasts earthquakes. During operation, the system generates a relative intensity (RI) map of a geographic region, wherein the RI map represents a normalized intensity in seismic activity over the geographic region during a time period from t₀ to t₂, wherein t₀<t₂. The system additionally generates a pattern informatics (PI) map of the geographic region, wherein the PI map represents a time-averaged change in the normalized intensity in seismic activity during a change interval from t₁ to t₂, wherein t₁<t₂. Next, the system compares the PI map against the RI map. The system then forecasts an earthquake with a magnitude greater than m within the geographic region based on the comparison between the PI map and the RI map.

### RELATED APPLICATION

This application hereby claims priority under 35 U.S.C. §119 to U.S. Provisional Patent Application No. 60/897,788, filed on 25 Jan. 2007, entitled “Using Earthquake Intensities to Forecast Earthquake Occurrence Times,” by the same inventors (Attorney Docket No. UC07-349-1 PSP).

### COLOR DRAWINGS

The patent or application file contains at least one drawing executed in color. Copies of this patent or patent application publication with color drawing(s) will be provided by the Office upon request and payment of the necessary fee.

### BACKGROUND

1. Field of the Invention

The present invention generally relates to forecasting seismic activity. More specifically, the present invention relates to a method and a system for predicting large magnitude earthquakes by combining a pattern informatics technique with a relative intensity analysis.

2. Related Art

Large magnitude earthquakes are devastating natural events which can have great social, scientific, and economic impact. For example, on 26 Dec. 2003 a magnitude 6.7 earthquake in Iran killed nearly 30,000 people, and on 16 Jan. 1995 a magnitude 6.9 earthquake in Japan caused an estimated $200 billion in property losses. Unfortunately, such large-scale earthquakes can occur at any time in San Francisco, Seattle, and other U.S. urban centers along the Pacific plate boundary, especially in Southern California.

The tremendous potential for loss of life and property makes reliable earthquake forecasting a primary research objective. However, after spending millions of dollars on observational programs which search for reliable precursory phenomena to predict earthquakes, very few successes have been reported and no precursors to large earthquake events have been identified which can provide reliable forecasts. In fact, the great difficulty in earthquake prediction has prompted debate as to whether earthquake forecasting is even possible.

While there is yet no proven technique for the reliable short-term prediction of earthquakes (from minutes to months), it is currently possible to make probabilistic hazard assessments for earthquake risk. For example, Rundle and Tiampo et al. have proposed an earthquake forecasting technique, referred to as “pattern informatics” or the “PI method” (see (i) Rundle et al., “Dynamics of seismicity patterns in systems of earthquake faults,” Geocomplexity and the Physics of Earthquakes, Geophys. Monogr. Ser., vol. 120, pp. 127-146 (AGU, Washington, D.C. 2000); (ii) Rundle et al., “Linear pattern dynamics in nonlinear threshold systems,” Phys. Rev. E. 61, 2418-2432; (iii) Rundle et al., “Self-organization in leaky threshold systems: The influence of near-mean field dynamics and its implications for earthquakes, neurobiology, and forecasting,” Proc. Natl. Acad. Sci. U.S.A. 99, 2514-2521: Suppl. 1; (iv) Rundle et al., “Statistical physics approach to understanding the multiscale dynamics of earthquake fault systems,” Rev. Geophys. 41(4), 1019, 2003). The PI method uses space-time correlations in seismic activity to identify geographical regions that have systematic and large fluctuations in seismic activity of the smallest events and quantifies their temporal variations. The output of this analysis provides a map of areas in a seismogenic region where earthquakes are forecast to occur in a future time span, generally five to ten years.

Separately, a relative intensity (RI) analysis technique has been widely used to forecast future large earthquakes in a specified region. The RI analysis technique is largely based on the assumption that future large earthquakes will occur where the average seismicity rate has a value greater than a predetermined threshold. In this technique, the seismogenic area is subdivided into cells of equal size. In each cell, the rate of occurrence of earthquakes is computed for a given training time period. The resulting cells with seismicity above a given threshold define “hotspots” where large earthquakes are forecast to occur in a specified forecast period. The output of the RI analysis technique is a map of “hotspot” areas.

Although both the PI and RI techniques have been shown to be good predictors of locations for future large seismic events, neither technique alone can reliably forecast major earthquakes in advance, or reliably assess the risk for major earthquakes.

### SUMMARY

One embodiment of the present invention provides a system that forecasts earthquakes. During operation, the system generates a relative intensity (RI) map of a geographic region, wherein the RI map represents a normalized intensity in seismic activity over the geographic region during a time period from t₀ to t₂, wherein t₀<t₂. The system additionally generates a pattern informatics (PI) map of the geographic region, wherein the PI map represents a time-averaged change in the normalized intensity in seismic activity during a change interval from t₁ to t₂, wherein t₁<t₂. Next, the system compares the PI map against the RI map. The system then forecasts an earthquake with a magnitude greater than m within the geographic region based on the comparison between the PI map and the RI map.

In a variation on this embodiment, prior to generating the RI map and the PI map, the system partitions the geographic region into a mesh of pixel boxes based on the forecast magnitude m.

In a further variation on this embodiment, the system generates the RI map of the geographic region by obtaining a number of earthquakes n(xᵢ;t₀,t₂) for each pixel box xᵢ that have magnitude values greater than a cutoff magnitude m_{C}. These earthquakes occur within the pixel box between t₀ and t₂. The system then computes a total number of earthquakes which occur between t₀ and t₂ by summing the number of earthquakes greater than m_{C} over all the pixel boxes. Next, the system computes a normalized intensity I(xᵢ;t₀,t₂) by dividing the number of earthquakes n(xᵢ;t₀,t₂) by the total number of earthquakes.

In a further variation, the system generates the PI map of the geographic region by obtaining a number of earthquakes n(xᵢ;t_{b},t₂) having magnitude values greater than the cutoff magnitude m_{C} which occur within each pixel box xᵢ between t_{b} and t₂. The system additionally obtains a number of earthquakes n(xᵢ;t_{b},t₁) having magnitude values greater than the cutoff magnitude m_{C} which occur within each pixel box xᵢ between t_{b} and t₁, wherein t₂>t₁>t_{b}. Next, the system computes rates of the earthquakes S(xᵢ,t_{b},t₂) and S(xᵢ,t_{b},t₁) by dividing n(xᵢ;t_{b},t₂) and n(xᵢ;t_{b},t₁) by (t₂−t_{b}) and (t₁−t_{b}), respectively. The system then obtains time-averaged changes S(xᵢ;t₀,t₂) and S(xᵢ;t₀,t₁) by averaging S(xᵢ,t_{b}, t₂) and S(xᵢ,t_{b},t₁) over all values t_{b} in the ranges t₀≦t_{b}<t₂ and t₀≦t_{b}<t₁, respectively. The system next computes the spatial means and standard deviations of Ŝ(xᵢ;t₀,t₂) and Ŝ(xᵢ;t₀,t₁) and normalizes Ŝ(xᵢ;t₀,t₂) and Ŝ(xᵢ;t₀,t₁) by subtracting the respective means and dividing by the respective standard deviations so that the resulting functions S̅(xᵢ;t₀,t₂) and S̅(xᵢ;t₀,t₁) have zero means and unit variances. The system computes a change in the normalized intensity Δ S̅(xᵢ;t₀,t₁,t₂) from t₁ to t₂ using Δ S̅(xᵢ;t₀,t₁,t₂)= S̅(xᵢ;t₀,t₂)− S̅(xᵢ;t₀,t₁). Next, the system computes the square value Δ S̅²(xᵢ;t₀,t₁,t₂) and then normalizes Δ S̅²(xᵢ;t₀,t₁,t₂) over the geographic region to obtain the PI map ΔI(xᵢ;t₀,t₁,t₂) so that the integral of the PI map ΔI(xᵢ; t₀,t₁,t₂) over the geographic region is equal to 1.

In a further variation, the system chooses t₂ such that a number of greater than forecast magnitude m earthquakes occurred within a test interval [t₂, t_{C}] is substantially equal to a predetermined number M. Note that t_{C} is a current time.

In a further variation, the system chooses t₁ based on the chosen t₂.

In a further variation, the system compares the PI map against the RI map by predicting one or more earthquakes with a magnitude greater than forecast magnitude m using the RI map and the PI map respectively and comparing the predictions of the RI map and the PI map.

In a further variation, the system predicts the earthquakes using the RI map or the PI map by first choosing an evaluation time window [t_{A},t_{B}] during which N earthquakes with magnitude greater than forecast magnitude m are recorded. The system then computes a respective probability distribution over the evaluation time window for the geographic region for the RI map or the PI map. In doing so, each pixel box in the probability distribution is associated with a probability value of recording an earthquake of magnitude greater than forecast magnitude m during the evaluation time window.

In a further variation, the system computes the probability distributions over the evaluation time window for the geographic region for the RI map or the PI map by converting the RI map and the PI maps into respective binary forecast maps.

In a further variation, the system converts the RI map and the PI maps into respective binary forecast maps by receiving a threshold value D, wherein 0≦D≦1. Next, for each pixel box xᵢ in the RI map and the PI map, the system compares the respective value of the RI map and the PI map at pixel box xᵢ against D. If the respective value of the RI map and the PI map is greater than D, the system produces a binary value B(xᵢ)=1 for the pixel box xᵢ. Otherwise, the system produces a binary value B(xᵢ)=0 for the pixel box xᵢ.

In a further variation, the evaluation time window [t_{A},t_{B}] is the test interval [t₂,t_{C}].

In a further variation, the system compares the predictions of the RI map and PI map by: building a respective receiver operating characteristic (ROC) curve for the RI map and the PI map for a given current time t_{C}; computing a difference function by subtracting the ROC curve for the PI map from the ROC curve for the RI map; and obtaining a difference ΔA in the predictions by integrating an area under the difference function over the ROC domain.

In a further variation, the system constructs a risk classifier ΔA(t_{C}) while varying the current time t_{C}.

In a further variation, the system builds the respective ROC curve for the RI map and the PI map. During operation, the system determines a subset of N pixel boxes x_{q}(m) within the geographic region wherein greater than forecast magnitude m earthquakes are recorded during the evaluation time window. Next, for each threshold value D, the system converts the RI map and the PI map into a respective binary forecast map and subsequently computes a respective hit rate and a respective false alarm rate based on the respective binary forecast map associated with D and the N pixel locations x_{q}(m). Note that the system builds the respective ROC curve for the RI map and the PI map by varying the threshold value D.

In a further variation, the system computes the hit rate and the false alarm rate by constructing a contingency table based on the binary forecast map associated with D and the N pixel locations x_{q}(m).

In a further variation, the system forecasts an earthquake with a magnitude greater than m based on the comparison between the PI map and the RI map by forecasting if the geographic region is currently in a high-risk time period for an earthquake with a magnitude greater than m.

In a further variation, the system forecasts if the geographic region is currently in a high-risk time period by determining if the risk classifier ΔA(t_{C})>0 at a current time t_{C}.

In a further variation, the system determines that the geographic region is currently in a low-risk time period if the risk classifier ΔA(t_{C})<0 at a current time t_{C}.

In a further variation, the system identifies an onset time of a high-risk time period when the risk classifier transitions from ΔA(t_{C})<0 to ΔA(t_{C})>0.

In a further variation, the system determines a probability of an occurrence of an earthquake with a magnitude greater than m based on an elapsed time from the onset time of a high-risk time period and a Weibull distribution.

In a variation on this embodiment, the system forecasts the earthquake within the geographic region by forecasting locations and a time window for the earthquake.

In a further variation, the system partitions the geographic region into a mesh of pixel boxes based on the given magnitude m. Specifically, the system uses a larger pixel box for a higher forecast magnitude m.

In a further variation, choosing the evaluation time window [t_{A},t_{B}] involves choosing a longer time window for a higher forecast magnitude m.

### BRIEF DESCRIPTION OF THE FIGURES

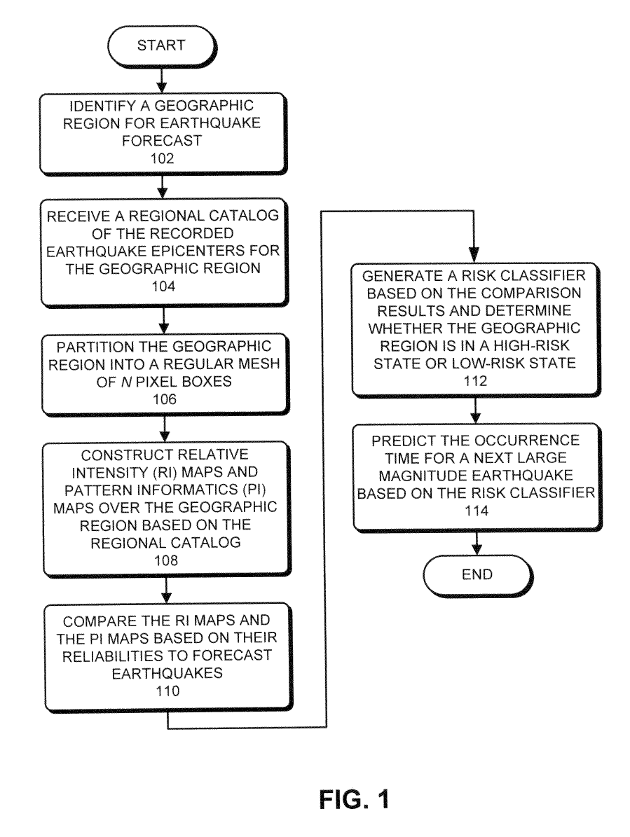

FIG. 1 presents a flowchart illustrating the combined pattern informatics (PI)-relative intensity (RI) technique for earthquake forecasting in accordance with an embodiment of the present invention.

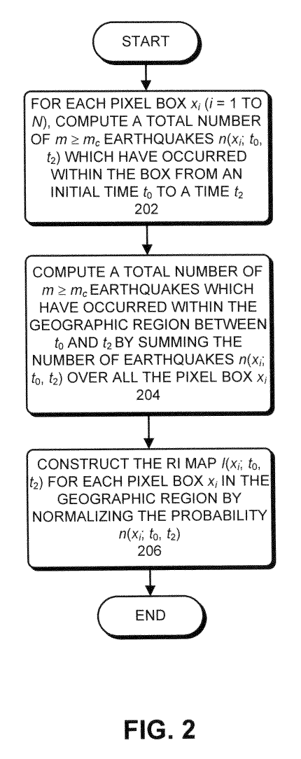

FIG. 2 presents a flowchart illustrating the process of constructing a RI map in accordance with an embodiment of the present invention.

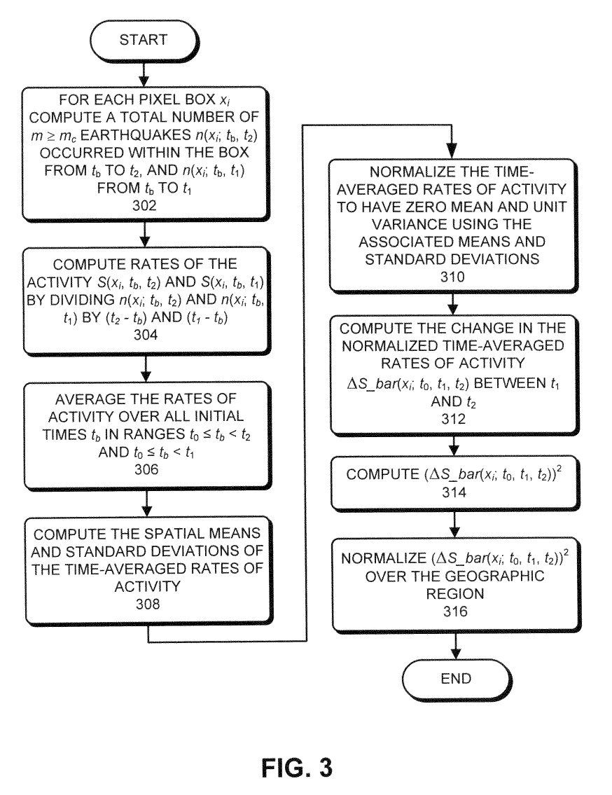

FIG. 3 presents a flowchart illustrating the process of constructing a PI map in accordance with an embodiment of the present invention.

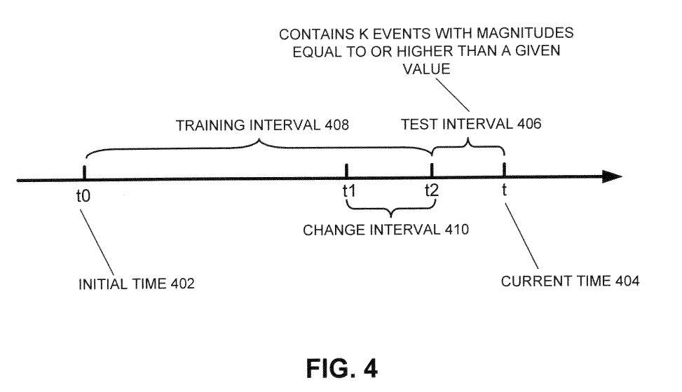

FIG. 4 presents a time-progression graph illustrating the relation among the set temporal parameters t₀,t₁, and t₂ and the procedure to determine the same in accordance with an embodiment of the present invention.

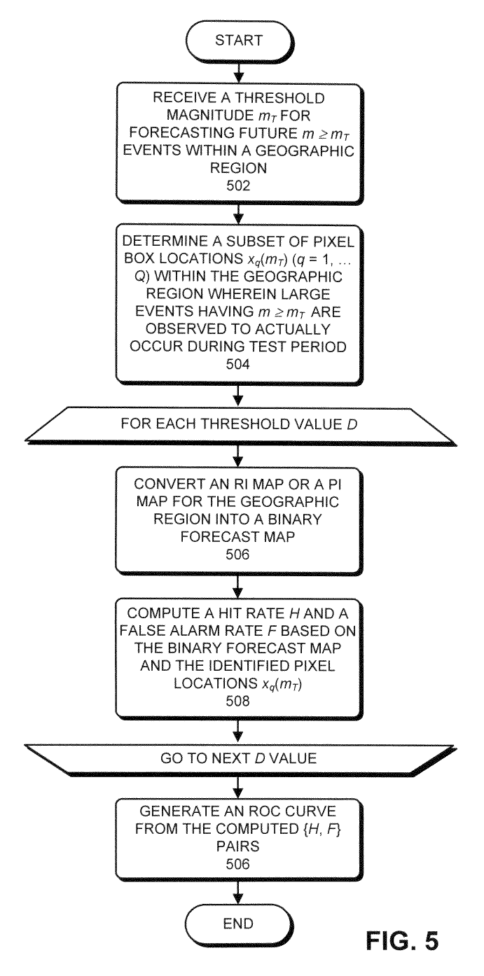

FIG. 5 presents a flowchart illustrating the process of constructing an ROC curve from a binary forecast map in accordance with an embodiment of the present invention.

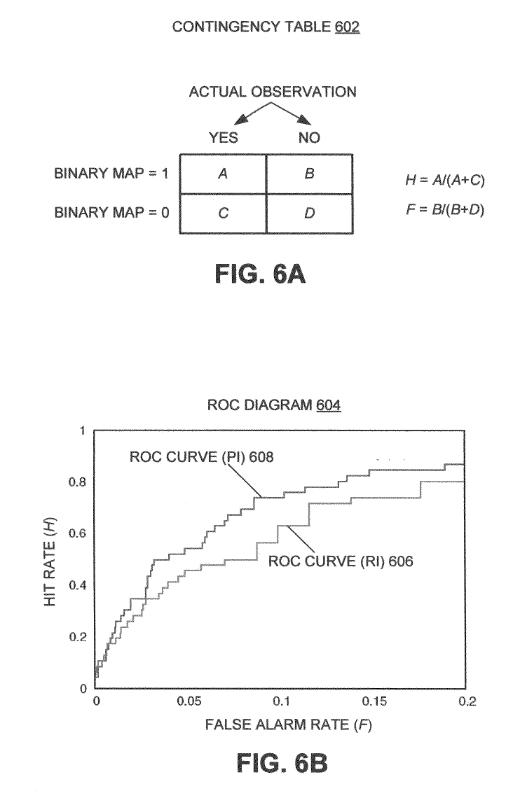

FIG. 6A illustrates an exemplary contingency table for computing the hit rate and false alarm rate in accordance with an embodiment of the present invention.

FIG. 6B illustrates an exemplary ROC diagram comprising a pair of exemplary ROC curves and corresponding to the RI and PI maps in accordance with an embodiment of the present invention.

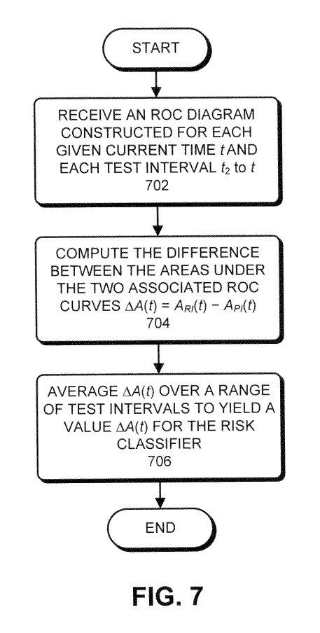

FIG. 7 presents a flowchart illustrating the process of generating a risk classifier from the ROC diagram in accordance with an embodiment of the present invention.

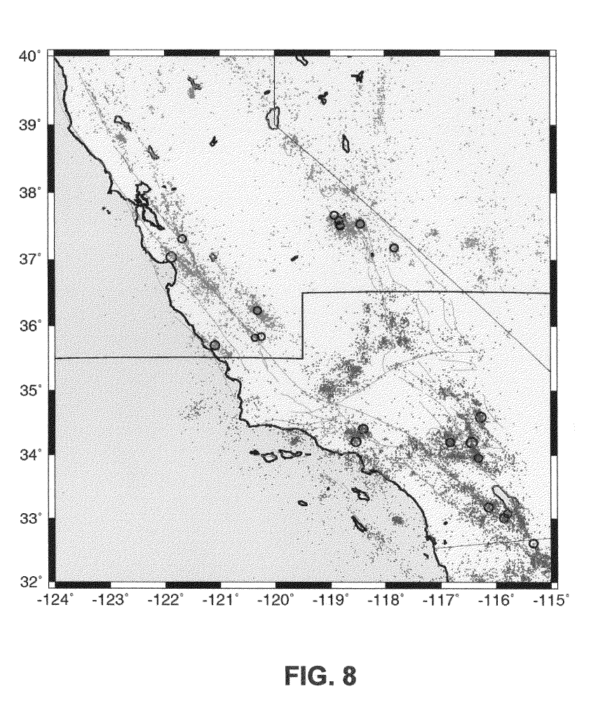

FIG. 8 illustrates the selected earthquake locations with “northern” epicenters shown in red and “southern” epicenters shown in blue in accordance with an embodiment of the present invention.

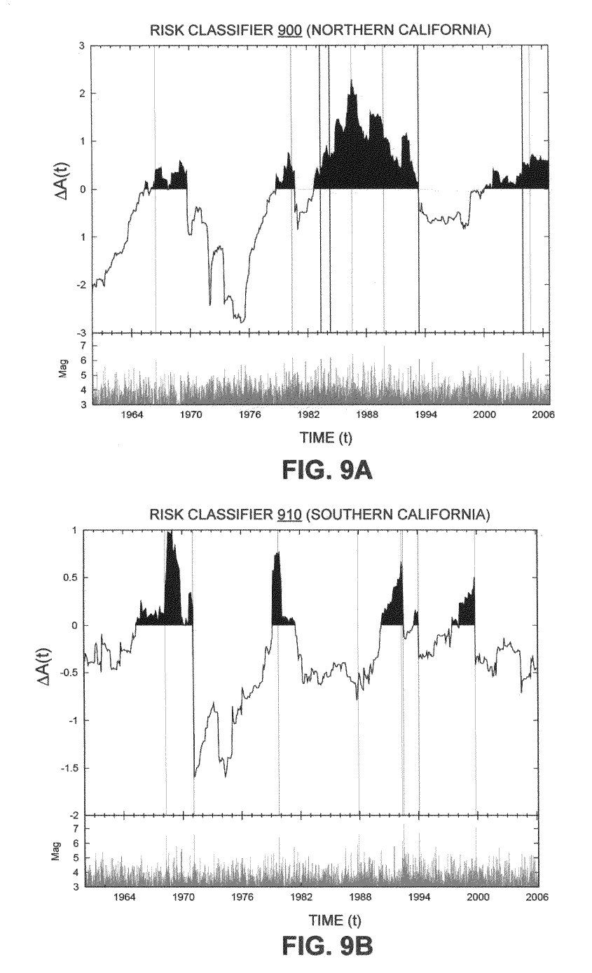

FIG. 9A illustrates a risk classifier plot for Northern California in accordance with an embodiment of the present invention.

FIG. 9B illustrates a risk classifier plot for Southern California in accordance with an embodiment of the present invention.

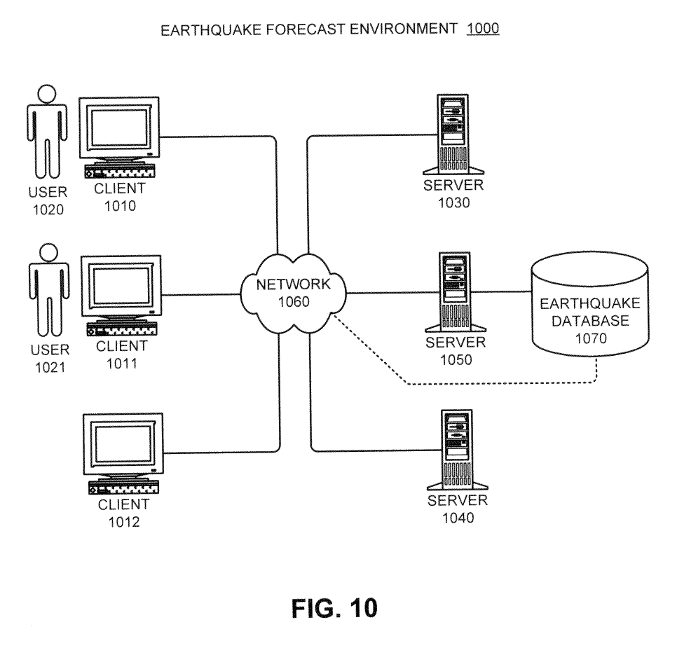

FIG. 10 illustrates an earthquake forecast environment in accordance with an embodiment of the present invention.

Table 1 provides the dates, locations, and magnitudes of earthquakes with m≧6.0 since 1960 in California in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited t₀, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

### Overview

It is well known that earthquakes do not occur randomly in space and time. Foreshocks, aftershocks, precursory activation, and quiescence are just some of the patterns recognized by seismologists. However, there exists no known method that can reliably forecast major earthquakes in advance, or to reliably assess the current risk potential for major earthquakes.

One embodiment of the present invention provides an earthquake forecasting technique that combines the pattern informatics (PI) technique with the relative intensity (RI) analysis, referred to as a “RIPI” (“Relative Intensity-Pattern Informatics) technique. This RIPI technique can be used to accurately assess the space-time risk potential and to reliably forecast earthquakes in any given region of the world where adequate earthquake seismicity catalogs are available.

In one embodiment of the present invention, the RIPI technique separately generates two probability measures that define the locations of future earthquake occurrence, in the forms of RI maps and PI maps, using earthquake seismicity catalogs for a seismically active region. Note that the RI maps represent long-term averages of small earthquakes in the geographic region, whereas the PI maps represent an average change in intensity in seismic activity over short time scales.

In one embodiment of the present invention, the RI maps and PI maps are used to construct Receiver Operating Characteristic (“ROC”) diagrams. Next, the ROC diagrams associated with the RI maps and PI maps are compared, and the comparison results are used to define a risk classifier for determining when the seismically active region is in a seismically high-risk or low-risk state. Note that the RIPI technique in essence compares long-term averages of small earthquakes with the root-mean-square change in activity over much shorter time scales to determine the current risk of much larger and far more destructive earthquakes.

In one embodiment of the present invention, the RIPI technique has successfully used events in California having magnitudes m˜3 to assess the current risk of major events having m>6. The RIPI technique has also successfully used events world-wide having magnitudes m˜5 to assess the current risk of major events having m>8. In particular, the RIPI technique indicates that when a geographic region (such as California) is determined by the RIPI technique to be in a high-risk state, the average number of major earthquakes having magnitude m>6 is about 1 per year. Conversely, when the region is in a low-risk state, the average number of major earthquakes having magnitude m>6 is less than 0.05 per year. Using extensions of the RIPI technique, the probable locations of the future major events (m>6) can be identified in California to within +/−50 km. Furthermore, by analyzing the statistics of events in the high-risk time periods, one can determine the probability that a major earthquake will occur as a function of time since the occurrence of the last such earthquake.

### The RIPI Technique

FIG. 1 presents a flowchart illustrating the RIPI technique for earthquake forecasting in accordance with an embodiment of the present invention.

The system starts by identifying a geographic region for earthquake forecast (step 102). In one embodiment, the geographic region is a seismically active region, such as California. The system then receives a regional catalog of the recorded earthquake epicenters for the geographic region and creates a time series by course-graining the catalog in regular time intervals (typically daily to monthly) (step 104). In one embodiment of the present invention, to ensure catalog completeness (i.e., sufficiently high confidence in recording all the events), the system selects seismic events above a predetermined threshold magnitude m_{C}, which may be referred to as a “cutoff threshold.” In one embodiment of the present invention, m_{C}≅3.

Next, the system partitions the geographic region into a regular mesh of N pixel boxes (step 106). In one embodiment of the present invention, the partitioning process divides the geographic region into 0.1°×0.1° square pixel boxes centered on each coordinate x. Note that the size of these pixel boxes can vary depending on the associated latitudes. Hence, the number of earthquakes within a box i, centered at xᵢ, between time t₀ and t₁ can be denoted as n(xᵢ;t₀,t₁). Note that in some embodiments, the system can partition the geographic region into pixel boxes of other sizes and shapes. In one embodiment of the present invention, the size of the pixel boxes can vary based on a forecast magnitude m_{T}. For example, larger pixel box sizes may be used for forecasting a larger magnitude m_{T}.

Referring back to FIG. 1, after the geographic region is partitioned, the system next constructs relative intensity (RI) maps and pattern informatics (PI) maps over the geographic region based on the regional catalog (step 108). We describe the procedures of constructing the RI map and PI map in more detail below. Next, the system compares the RI maps and the PI maps based on their reliabilities to forecast earthquakes (step 110). In an embodiment of the present invention, the comparison involves using the RI maps and PI maps to construct receiver operating characteristic (ROC) diagrams, and then comparing the ROC diagrams associated with the RI maps and PI maps. The procedure for generating ROC diagrams from the RI map and PI map is described in more detail below.

Next, the system generates a risk classifier as a function of time based on the comparison results and subsequently determines whether the geographic region is in a seismically high-risk state or low-risk state (step 112). The procedure for generating the risk classifier from the ROC diagrams of the RI map and PI map is described in more detail below. The system then predicts the occurrence time for the next large magnitude earthquake based on the risk classifier state (step 114).

### Constructing the RI Map

In one embodiment of the present invention, a relative intensity (RI) map of the geographic region is computed based on the recorded seismic events in the regional catalog having magnitudes greater than a cutoff magnitude m_{C}.

FIG. 2 presents a flowchart illustrating the process of constructing an RI map in accordance with an embodiment of the present invention.

During operation, for each pixel box xᵢ (i=1 to N), the system computes a total number of m≧m_{C} earthquakes n(xᵢ;t₀,t₂) which have occurred within the box from an initial time to until a later time t₂ (step 202). Note that m_{C} is the cutoff threshold magnitude. Hence, n(xᵢ;t₀,t₂) can be expressed as:

$$n ( {x}_{i} ; {t}_{0} , {t}_{2} ) = {\sum }_{t = {t}_{0}}^{{t}_{2}} n ( {x}_{i} ; t ) . \qquad ( 1 )$$

In one embodiment of the present invention, the time t₂ is allowed to vary. We describe how to specify t₂ in more detail below. Note that to can be determined as the start time for the records in the regional catalog. In one embodiment of the present invention, n(xᵢ;t₀,t₂) can be regarded as a non-normalized probability for forecasting the location xᵢ of future m≧m_{T} events for times t>t₂, where m_{T} is the forecast threshold.

The system next computes a total number of m≧m_{C} earthquakes which have occurred within the geographic region between t₀ and t₂ by summing the number of earthquakes n(xᵢ;t₀,t₂) over all the pixel box xᵢ (step 204). The system subsequently constructs the RI map I(xᵢ;t₀,t₂) for each pixel box xᵢ in the geographic region by normalizing the probability n(xᵢ;t₀,t₂) (step 206) such that:

$$I ( {x}_{i} ; {t}_{0} , {t}_{2} ) = \frac{n ( {x}_{i} ; {t}_{0} , {t}_{2} )}{{\sum }_{i = 1}^{N} n ( {x}_{i} ; {t}_{0} , {t}_{2} )} . \qquad ( 2 )$$

Note that an integral of the RI map I(xᵢ;t₀,t₂) over the geographic region is equal to unity.

Also note that the RI map represents a normalized intensity in seismic activity over the geographic region during a time period from to t (t₀<t). As can be observed, RI map I(xᵢ;t₀,t₂) can be used as a probability measure of the historic seismic rate as a function of location. Previous published works have indicated that this normalized probability can be by itself a good predictor of locations within the geographic region for future large seismic events with m_{T}≈5.

Although an RI map can be constructed using the above-described process, in general the RI map construction is not meant to be limited to the particular embodiment illustrated in FIG. 2.

### Constructing the PI Map

A pattern informatics (PI) map of the geographic region represents an average change in the normalized intensity in seismic activity during a change interval from t₁ to t₂ (t₁<t₂). In one embodiment of the present invention, the PI map ΔI(xᵢ;t₀,t₁,t₂) is constructed based on the above-described RI map I(xᵢ;t₀,t₂) and by computing the average change in earthquake intensity over a time interval Δt=t₂−t₁. In some embodiments of the present invention, the change interval Δt is chosen to be around 13 years. In some other embodiments, the change interval Δt may include shorter or longer time intervals depending on the quality of the regional catalog.

FIG. 3 presents a flowchart illustrating the process of constructing a PI map in accordance with an embodiment of the present invention.

During operation, for each pixel box xᵢ (i=1 to N), the system computes a total number of m≧m_{C} earthquakes n(xᵢ;t_{b},t₂) which have occurred within the box from an initial time t_{b} to a time t₂ (step 302). The system additionally computes n(xᵢ;t_{b},t₁) which have occurred within the same box from t_{b} to a later time t₁ (t₂>t₁>t_{b}) (step 302). In one embodiment, the initial time t_{b} is greater than the initial time to used to compute the RI map. In another embodiment, the initial time t_{b} is equal to the initial time to used to compute the RI map.

Next, the system computes rates of seismic activity S(xᵢ;t_{b},t₂) and S(xᵢ;t_{b},t₁) by dividing n(xᵢ;t_{b},t₂) and n(xᵢ;t_{b},t₁) by (t₂−t_{b}) and (t₁−t_{b}) respectively (step 304):

$$\begin{matrix}S ( {x}_{i} ; {t}_{b} , {t}_{2} ) = \frac{n ( {x}_{i} ; {t}_{b} , {t}_{2} )}{{t}_{2} - {t}_{b}} , \\ and & ( 3 a ) \\ S ( {x}_{i} ; {t}_{b} , {t}_{1} ) = \frac{n ( {x}_{i} ; {t}_{b} , {t}_{1} )}{{t}_{1} - {t}_{b}} . & ( 3 b )\end{matrix}$$

The system then averages the rates of seismic activity over all initial times t_{b} in the respective ranges t₀≦t_{b}<t₂ and t₀≦t_{b}<t₁ (step 306):

$$\begin{matrix}\hat{S} ( {x}_{i} ; {t}_{0} , {t}_{2} ) = \frac{{\sum }_{{t}_{b} = {t}_{0}}^{{t}_{2}} S ( {x}_{i} ; {t}_{b} , {t}_{2} )}{{t}_{2} - {t}_{0} - α} , \\ and & ( 4 a ) \\ \hat{S} ( {x}_{i} ; {t}_{0} , {t}_{1} ) = \frac{{\sum }_{{t}_{b} = {t}_{0}}^{{t}_{1}} S ( {x}_{i} ; {t}_{b} , {t}_{1} )}{{t}_{1} - {t}_{0} - α} , & ( 4 b )\end{matrix}$$

wherein α is a predetermined small positive time value, for example, α can be equal to 1 year). Note that the time average of step 306 helps to reduce the relative importance of random fluctuations (i.e., noise) in the cataloged seismic activity.

Next, the system computes the spatial mean and the standard deviation for each of Ŝ(xᵢ;t₀,t₂) and Ŝ(xᵢ;t₀,t₁) over the entire geographic region (step 308), wherein the spatial means and the standard deviations are defined as:

$$\begin{matrix}{μ}_{{S}_{j}} = \frac{{\sum }_{i = 1}^{N} \hat{S} ( {x}_{i} ; {t}_{0} , {t}_{j} )}{N} , \\ j = 1 , 2 \\ and & ( 5 ) \\ {σ}_{{S}_{j}} = \frac{{\sum }_{i = 1}^{N} ( {( \hat{S} ( {x}_{i} ; {t}_{0} , {t}_{j} ) )}^{2} - {μ}_{{S}_{j}^{2}} )}{N} , \\ j = 1 , 2 , & ( 6 )\end{matrix}$$

wherein the sum is performed over the geographic region, and wherein N represents the total number of pixel boxes in the geographic region.

The system then normalizes Ŝ(xᵢ;t₀,t₂) and Ŝ(xᵢ;t₀,t₁) to have zero mean and unit variance using the associated means and standard deviations (step 310). Specifically, the system computes a pair of normalized intensities S̅(xᵢ;t₀,t₂) and S̅(xᵢ;t₀,t₁) by using:

$$\begin{matrix}\overline{S} ( {x}_{i} ; {t}_{0} , {t}_{2} ) = \frac{\hat{S} ( {x}_{i} ; {t}_{0} , {t}_{2} ) - {μ}_{2}}{{σ}_{2}} , \\ and & ( 7 a ) \\ \overline{S} ( {x}_{i} ; {t}_{0} , {t}_{1} ) = \frac{\hat{S} ( {x}_{i} ; {t}_{0} , {t}_{1} ) - {μ}_{1}}{{σ}_{1}} . & ( 7 b )\end{matrix}$$

Next, the system computes the change in the normalized intensity Δ S̅(xᵢ;t₀,t₁,t₂) from t₁ to t₂ (step 312) based on:

Δ S̅(xᵢ;t₀,t₁,t₂)= S̅(xᵢ;t₀,t₂)− S̅(xᵢ;t₀,t₁) (8)

The system subsequently computes the square value of the time-averaged normalized intensity Δ S̅²(xᵢ;t₀,t₁,t₂) (step 314). Finally, the system obtains the PI map by normalizing Δ S̅² (xᵢ;t₀,t₁,t₂) over the geographic region so that the integral of the PI map ΔI(xᵢ;t₀,t₁,t₂) over the geographic region is equal to unity (step 316):

$$Δ I ( {x}_{i} ; {t}_{0} , {t}_{1} , {t}_{2} ) = \frac{Δ {\overline{S}}^{2} ( {x}_{i} ; {t}_{0} , {t}_{1} , {t}_{2} )}{{\sum }_{i = 1}^{N} Δ {\overline{S}}^{2} ( {x}_{i} ; {t}_{0} , {t}_{1} , {t}_{2} )} . \qquad ( 9 )$$

Note that previous published works have indicated that this normalized probability (i.e., the PI map) can be by itself a good predictor of locations within the geographic region for future large seismic events with m_{T}≈5. Note that based on the construction process, this probability can be viewed as a probability based upon the squared change in earthquake intensity.

Note that the above-described PI technique is a variation on a previous PI technique published in [Rundle et al., “Statistical physics approach to understanding the multiscale dynamics of earthquake fault systems,” Rev. Geophys. 41(4), 1019, 2003]. Although a PI map can be constructed using the above-described process, in general the PI map construction is not meant to be limited to the particular embodiment illustrated in FIG. 3.

### Comparing the RI Map and the PI Map

Establishing the RI Map and the PI Map

Referring to equations (2) and (8), note that in order to establish an RI map or a PI map, one needs to determine all three temporal parameters t₀,t₁, and t₂. More specifically, FIG. 4 presents a time-progression graph illustrating the relation among the set temporal parameters t₀,t₁, and t₂ and the procedure to determine the same in accordance with an embodiment of the present invention. Note that to is chosen to be the initial time of event counting (illustrated as initial time 402 in FIG. 4). In the example of California, one can choose to =1 Jan. 1932. However, another initial time to can be specified based on the available regional catalog.

To determine t₂, we first introduce a “current time” t (illustrated as current time 404 in FIG. 4). Note that current time t is a variable time. In one embodiment of the present invention, t can be any time from to a present time (e.g., 31 Dec. 2007). In one embodiment of the present invention, to determine the time t₂, we go back from current time t to count a predetermined number of K events having magnitudes greater than or equal to a predetermined magnitude m. We then refer to the beginning of this time period which includes K magnitude ≧m events as t₂. We refer to the time period between t₂ and current time t as the “test interval,” which is illustrated as test interval 406 in FIG. 4, and refer to the time period from t₀ to t₂ as the “training interval,” which is illustrated as training interval 408 in FIG. 4. Generally, the value of t₂ is determined so that the earthquakes occurring within the test interval t₂→t include a desired number of m≧m_{T} events, wherein m_{T} is the threshold magnitude for forecasting future large earthquakes.

Note that once t₂ is determined, t₁ can be chosen such that t₂−t₁=Δt, which is referred to as the change interval 410 in FIG. 4. We have described how to choose the change interval previously in the process associated with constructing the PI map.

Once a set of temporal parameters t₀,t₁, and t₂ are determined, a set of RI map and PI map can be created using the above-described procedures. Note that the PI and PI maps are computed based on the m≧m_{C} events which occur during the training interval, wherein m_{C} is a cutoff threshold magnitude (e.g., the smallest magnitude being considered). Next, the RI map and PI map which both represent probability measures within the geographic region of interest, are used to forecast locations of earthquakes having m≧m_{T} during t₂ to t, i.e., the test interval. We describe this forecasting process in more detail below.

We now describe how to choose parameters K and m for the test period 406. In one embodiment of the present invention, we consider the Gutenberg-Richter frequency-magnitude relation f=10^{a}·10^{-bm}, wherein f is the number of seismic events per unit time having magnitude larger than m, and parameters a and b are constants. In one embodiment, a specifies the level of seismic activity in the region, and b≅1. Note that f⁻¹ specifies a time scale for events larger than m. It can be observed from the frequency-magnitude relation that within a similar time period, one event with m≧6.0 is associated with on average 10 m≧5.0 events, 100 m≧4.0 events, 1000 m≧3.0 events, and so on. In one embodiment of the present invention, choosing parameter K for a given m value is based on the above observation. For example, if m=3 and m_{T}=6,to ensure that there is at least one m_{T}=6 event within the test period, parameter K is chosen to be at least 1000. Next, for the combination of [m=3, K=1000], a set of times t₀,t₁, and t₂ are determined and a pair of RI and PI maps are subsequently created. Note that different combinations of [m, K] give rise to different sets of t₁, and t₂.

Converting RI and PI Maps into Binary Forecast Maps

As mentioned previously, both the RI map and the PI map can be regarded as normalized probabilities at the associated pixel box locations, because they are represented by numerical values between 0 and 1 at all the pixel box locations (referring to equations (2) and (8)).

In one embodiment of the present invention, the established RI and PI maps (i.e., the computed maps) can be used to perform binary forecasts based on a given decision threshold D, wherein 0≦D≦1. Specifically, pixel box locations in the RI map or in the PI map associated with values greater than D constitute locations where future large earthquakes are hypothesized to preferentially occur. Note that binary forecast is a well-known and broadly utilized technique for constructing forecasts of future event locations and has been widely used in tornado and severe storm forecasting (see Forecast Verification: A Practitioner's Guide in Atmospheric Science, by I. T. Jolliffe and D. B. Stephenson, 2003).

More specifically, for a given decision threshold value D, the pixel box xᵢ within RI map is set to B_{RI}(xᵢ)=1 where I(xᵢ;t₀,t₂)>D and B_{RI}(xᵢ)=0 otherwise. Similarly, the pixel box xᵢ within PI map is set to B_{PI}(xᵢ)=1 where ΔI(xᵢ;t₀,t₁,t₂)>D, and is set to B_{PI}(xᵢ)=0 otherwise. In this way, each of the RI and PI maps is converted into a binary map in the geographic region of interest with binary values for all the pixel boxes xᵢ. We refer to these converted RI and PI maps as binary RI and PI maps, and the locations where B_{RI}(xᵢ)=1 or B_{PI}(xᵢ)=1 as “hot spots.” In one embodiment of the present invention, the set of pixel boxes associated with B_{RI}(xᵢ)=1 or B_{PI}(xᵢ)=1 constitute locations where future events m≧m_{T} are likely to occur under the chosen forecast. Similarly, the locations where B_{RI}(xᵢ)=0 or B_{PI}(xᵢ)=0 are sites where future events m≧m_{T} are unlikely to occur. Note that when decision-threshold value D varies, the original RI and PI maps can be converted into a different pair of binary RI and PI maps.

Constructing ROC Diagrams from the Binary Forecast Maps

Note that a comparison of the forecasting capabilities of the two binary forecast maps can be used to determine which map (RI or PI) is a better predictor of the locations of future large earthquakes during a future evaluation period t>t₂. Recall that all RI maps and PI maps are generated based on the actual recorded earthquakes within the training interval t₁→t₂. In one embodiment of the present invention, comparing the forecast capabilities of the RI maps and PI maps involves first testing the RI maps and PI maps by forecasting locations of earthquakes during the test interval t₂→t, and then comparing the forecast results against actually recorded earthquakes within the test interval t₂→t. More specifically, comparing the forecast results against actually recorded earthquakes involves performing a receiver operating characteristic (ROC) analysis for each of the associated binary maps. This ROC analysis on a given binary map generates an ROC curve. Next, the ROC curves generated from the binary RI map and PI map are compared. Typically for a given threshold value D used to generate the binary maps, a map is a better predictor if the map scores more highly during the test interval 406.

FIG. 5 presents a flowchart illustrating the process of constructing an ROC curve from a binary forecast map in accordance with an embodiment of the present invention.

During operation, the system receives a threshold magnitude m_{T} for forecasting future m≧m_{T} events within a geographic region (step 502). For example, m_{T} can be 4, 5 or 6, etc. The system then determines a subset of pixel box locations x_{q}(m_{T}) (q=1, . . . Q) within the geographic region wherein large events having m≧m_{T} are observed to actually occur during the forecast verification period (i.e., the test period 406) t₂→t (step 504). Next, for a given decision threshold value D, the system converts an RI map or a PI map for the geographic region into a binary forecast map (step 506). The system then computes a pair of hit rate H and false alarm rate F based on the binary forecast map and the identified pixel locations x_{q}(m_{T}) (step 508). As the threshold value D varies, the system repeats step 508 and a full ROC curve comprising a series of points {H, F} is generated (step 510).

In one embodiment of the present invention, to compute the pair of hit rate H and false alarm rate F, a D-dependent 2×2 contingency table is first constructed based on the a binary forecast map and the identified pixel locations x_{q}(m_{T}). The contingency table has four entries, A, B, C, and D, which have values determined by a set of predetermined rules.

FIG. 6A illustrates an exemplary contingency table 602 for computing the hit rate and false alarm rate in accordance with an embodiment of the present invention. The A entry of contingency table 602 represents the number of “true positives.” More specifically, this is the number of pixel box locations within a binary forecast map which have values of 1 and are also among the identified pixel box locations x_{q}(m_{T}). Next, the B entry of contingency table 602 represents the number of “false positives.” More specifically, this is the number of pixel box locations within a binary forecast map which have values of 1 but are not among the identified pixel box locations x_{q}(m_{T}). The C entry of contingency table 602 represents the number of “false negatives.” More specifically, this is the number of pixel box locations within a binary forecast map which have values of 0 but are actually among the identified pixel box locations x_{q}(m_{T}). Finally, the D entry of contingency table 602 represents the number of “true negatives.” More specifically, this is the number of pixel box locations in a binary (RI or PI) map which have values of 0 and are not among the identified pixel box locations x_{q}(m_{T}). Consequently, the hit rate is defined as H=A/(A+C) and false alarm rate is defined as F=B(/(B+D). For example, for a geographical region with 8000 pixel boxes, if A=12, B=40, C=3, and D=7945,then the hit rate H=12/(12+3)=0.8 and false alarm rate F=40/(40+7945)=0.005, and this constitutes a point {0.005, 0.8} in the ROC curve. Note that A+B+C+D is the total number of pixel boxes within the geographical region N; wherein A+C=Q; and A+B=number of hot spots.

Note that as the threshold value D varies, a full ROC curve comprising a series of points {F, H} is generated. FIG. 6B illustrates an exemplary ROC diagram 604 comprising a pair of exemplary ROC curves 606 and 608 corresponding to RI and PI maps in accordance with an embodiment of the present invention. The horizontal axis of the ROC diagram 604 represents the false alarm rate F and the horizontal axis of the ROC diagram 604 represents the hit rate H. Hence, each ROC curve 606 and 608 is a parametric plot of the hit rate H(D), as a function of the false alarm rate, F(D), as D is varied from 0 to 1. Also note that each threshold value D corresponds to a pair of points in the two ROC curves. Moreover, each binary forecast map is used to generate a single data point in the ROC diagram. Note that ROC curves 606 and 608 can have a number of crossover points. However, in some ROC diagrams, the ROC curves for the RI and PI maps may not have crossover points.

Note that the effective range of threshold value D can be determined by the maximum value within the RI map or the PI map. Hence, for the RI map, Dε[0, max {RI(xᵢ)}] and for the PI map, Dε[0, max {PI(xᵢ)}]. Also note that for each ROC curve, there exists a point on the right end of the curve which is associated with a maximum false alarm rate Fₘₐₓ. Hence, the effective area under an ROC curve is between F E [0, Fₘₐₓ].

Note that in an ROC diagram, a perfect forecast of event occurrences is represented by two line segments: the first one connecting the points {F, H}={0, 0} to {F, H}={0, 1}, and the second one connecting {F, H}={0, 1} to {F, H}={1, 1}. A curve of this type can be described as forecasting all future earthquakes (i.e., H=1) with no false alarms (i.e., F=0). Moreover, the diagonal line H=F within the ROC diagram corresponds to a completely random forecast where the false alarm rate is the same as the hit rate and therefore no information is produced by the forecast.

Generating the Risk Classifier from the ROC Diagram

In one embodiment of the present invention, each ROC curve can be considered as a time dependent forecast H(F,t), wherein t is the current time as defined previously. Hence, each ROC diagram comprises an RI forecast H_{RI}(F,t) generated from a series of RI maps, and a PI forecast H_{PI}(F,t) generated from a series of PI maps. We hypothesize that a region evolves toward a major earthquake in response to persistent loading or stress increase may be associated with a precursory and systematic change in the separation of H_{RI}(F,t) for the RI maps and H_{PI}(F,t) for the PI maps. Recall that a PI map is a measure of the mean squared change of seismic activity intensity, or in other words, a measure of fluctuations in seismic activity intensity, during a time period t₁ to t₂. In contrast, an RI map is a measure of the average intensity over the entire time history from t₀ to t₂. Consequently, these two measures may be sensitive to different effects, and the time-dependent differences in the area between the two curves H_{RI}(F,t) and H_{PI}(F,t) may be sensitive to upcoming events.

In one embodiment of the present invention, we compute the area under each of the ROC curves as:

$$\begin{matrix}{A}_{RI} ( t ) = {\int }_{0}^{{F}_{max}} {H}_{RI} ( F , t ) d F , \\ and & ( 10 a ) \\ {A}_{PI} ( t ) = {\int }_{0}^{{F}_{max}} {H}_{PI} ( F , t ) d F , & ( 10 b )\end{matrix}$$

wherein Fₘₐₓ is the maximum false alarm rate. In one embodiment, Fₘₐₓ occurs around where dH/dF approaches 1. Consequently, the difference function ΔA(t) given by:

ΔA(t)=A_{RI}(t)−A_{PI}(t), (11)

wherein ΔA(t) is a function of the current time t over a range of choices of threshold magnitude m_{T}. Note that ΔA(t) can have both positive or negative values.

Recall that for a given current time t, time t₂ is determined based on the selection of a set of parameters [m, K]. In one embodiment of the present invention, each t₂ value is determined so that the earthquakes occurring within the test interval t₂→t include a desired number of magnitude ≧m events (˜K). Next, these magnitude ≧m events are used to test against the predictions of the RI and PI maps during the test interval t₂→t to generate the ROC curves.

However, it can be difficult to select a single optimal m value to determine the test interval 406. In one embodiment of the present invention, instead of using just one arbitrary m value, a range of m values are used. For example, one embodiment chooses a series of m=3, 3.1, 3.2, . . . , 6.0 at 0.1 magnitude intervals. Next, for each m value, the K parameter is computed based on the Gutenberg-Richter frequency-magnitude relation. For example, we create a series of [m, K] with N=1000 for m≧3.0 events, N=794 for m≧3.1 events, N 631 for m≧3.2 events, . . . , N=10 for m≧5.0 events and so on. In one embodiment, we terminate the sequence of m values at m≧5.0 due to an increasing statistics error. Note that each [m, K] pair corresponds to a unique test interval 406. Next, for each pair of [m, K], a new set of temporary parameter t₀,t₁, and t₂ are determined, a pair of RI and PI maps are created, and finally, a difference between the two ROC curves ΔA(t) is obtained. We then average the results of a set of ΔA(t) associated with the series of m values to obtain a single value ΔA(t) for a given current time t.

Note that the choice of threshold values m can be determined by the quality of the results. Either too many or too few chosen threshold values can cause unacceptably noisy results. In some embodiments of the present invention, an optimal balance is achieved when the successive differences in magnitude thresholds is greater than the error inherent in the magnitude determination, which is typically about 0.1-0.2 magnitude units. Furthermore, some results indicate that averaging over the series of magnitudes from m_{C} to m_{C}+2 produces acceptable results.

Finally, as the current time t is varied and the above procedures are repeated for each current time t, a risk classifier plot ΔA(t) can be created.

FIG. 7 presents a flowchart illustrating the process of generating a risk classifier from the ROC diagram in accordance with an embodiment of the present invention.

During operation, the system receives an ROC diagram constructed for each given current time t and test interval t₂→t (step 702). The system then computes the difference between the areas under the two associated ROC curves ΔA(t)=A_{RI}(t)−A_{PI}(t) (step 704). Next, the system averages ΔA(t) over a range of test intervals as described above to yield a final value ΔA(t) for the risk classifier (step 706). Note that in some embodiments, step 706 may be omitted.

### Constructing Risk Classifier Plot for California

To demonstrate the above-described RIPI technique, we apply this technique to the State of California using the Advanced National Seismic System (ANSS catalog) of earthquakes between latitude 32° N and 40° N, and longitudes 124° W and 115° W. Moreover, only events above a threshold magnitude m_{C}=3 are used to ensure catalog completeness.

FIG. 8 illustrates the selected earthquake locations with “northern” epicenters shown in red and “southern” epicenters shown in blue in accordance with an embodiment of the present invention. The region is partitioned into coarse-grained pixel boxes having a side length of 0.1°, about 11 km at these latitudes, approximately the rupture length of an m˜6 earthquake.

We then subdivide the entire region into northern and southern California sub-regions. The choice of where to divide the total region was made by considering the fault structure and local seismicity profile near 36° N latitude. FIGS. 9A and 9B illustrate a risk classifier plot 900 for Northern California and a risk classifier plot 910 for Southern California respectively in accordance with an embodiment of the present invention. The top subplot of each of FIGS. 9A and 9B is the risk classifier ΔA(t) as a function of current time t from 1 Jan. 1960 to 31 Dec. 2005. The horizontal axis of each risk classifier plot represents the current time t and the vertical axis of the plot represents the value of ΔA(t). Note that each risk classifier plot comprises multiple positive value regions interleaved with multiple negative value regions. The bottom subplot of each of FIGS. 9A and 9B is the earthquake magnitude as a function of time over the same period.

Furthermore, the vertical lines within each risk classifier plot represent the times of all m≧6.0 events in the respective region. Information related to these large events is provided in Table 1. From FIG. 9 and Table 1 we observe there are eleven m≧6.0 events in Northern California and ten such events in Southern California. These major events are concentrated into distinct episodes corresponding to distinct main shocks. Note that in the Northern California plot 900, all major events either occur during (black) time intervals where ΔA(t)>0 or they terminate such a time interval. In the Southern California plot, seven of the eight major events either occur during (black) time intervals where ΔA(t)>0 or they terminate such a time interval. If a binomial probability distribution is assumed, the chance that random clustering of these major earthquake episodes could produce this temporal concordance can be computed. For FIG. 9A, where black time intervals constitute 36.8% of the total, we compute a 0.19% chance that the concordance is due to random clustering. For FIG. 9B, the respective numbers are 19% of the total time interval, and 0.0058% chance due to random clustering. These results support a hypothesis that major earthquake episodes preferentially occur during time intervals when ΔA(t)>0. Furthermore, we note that currently in Northern California ΔA(t)>0.

### Predicting Future Large Earthquakes Using the Risk Classifier Plot

In one embodiment of the presenting invention, the risk classifier plot for a geographic region is used to identify whether the geographic region is currently within a “low-risk period” for occurrence of a large earthquake or a “high-risk period” for occurrence of such an event. More specifically, if the geographic region is currently within a time period wherein the associated risk classifier ΔA(t)>0 (i.e., a black period), it is considered within a high-risk period. In contrast, if the geographic region is currently within a time period wherein the associated risk classifier ΔA(t)<0 (i.e., a white period), it is considered within a low-risk period. Hence, the RIPI technique provides the capability to identify both low-risk periods when ΔA(t)<0 and high-risk periods when ΔA(t)>0 as times where future large events are hypothesized to be likely to occur.

In one embodiment of the present invention, it is observed that starting from the onset time of a high-risk period (i.e., when the risk classifier for the region goes positive), the probability of having an occurrence of a large earthquake can be described by a well-known statistical distribution: Weibull distribution. Consequently, based on the elapsed time from the onset time of a high-risk period and using the Weibull distribution, one can compute the probability of a future occurrence of a large earthquake event.

### Other Considerations and Variations

Catalog Selection

In one embodiment of the present invention, to produce acceptable results, the catalog of earthquakes used for the geographic region must be sufficiently long. In some embodiments, it is at least 25 years, and preferably 40 years. The completeness level of the catalog, which is referred to as the threshold magnitude m_{C}, defines the minimum magnitude events that can be used. Note that this is a common assumption used in the literature. The threshold magnitude m_{C} is commonly defined as the level at which all such events can be detected by the detection network.

In one embodiment of the present invention, the system can impose an additional requirement on the selected events. Specifically, the location errors of the smallest events having magnitude m_{C} must be smaller than about 1/10 of a linear dimension of the spatial pixel boxes with which the region is tiled. This requirement can lead to the determination, for example, that the data in California collected prior to 1960 is not sufficiently accurate in location to produce high quality results.

Catalog Partitioning

One important issue for the RIPI technique deals with partitioning the input catalog. Due to the way earthquake catalogs are constructed, they are often nonuniform and patchy (both in quality and statistical properties) over large regions. In some embodiments of the present invention, that accuracy of the RIPI technique may be improved by partitioning large regions into numerous uniform sub-regions.

Areas of Regional Coverage

Earthquake recording networks (“seismic networks”) typically are not uniform from one region to the next. For this reason, a practical consideration for regional classifiers using events down to m_{C}˜3 needs to be carefully chosen so that the spatially heterogeneous characteristics of the catalogs do not degrade the results. For example, we have chosen the “northern” and “southern” California regions as shown in FIG. 8 to satisfy these requirements. When using the ANSS catalog for the world-wide forecasts, the area of coverage may be less significant, because the catalog is largely homogeneous, but the completeness level is correspondingly and necessarily much higher, m_{C}˜5.

Integrating the ROC Curves

Referring back to Eqn. 9, note that computing the areas under the ROC curves involves integrating the ROC curves from 0 to Fₘₐₓ,the maximum false alarm rate. While we mentioned that Fₘₐₓ may occur around the place where dH/dF approaches 1,the actual place where this occurs may be dependent on how F and H are calculated and on how the ROC analysis is performed. Note that there are a number of ways to compute ROC curves, for example, using Moore neighborhoods or only performing the analysis on boxes which have historic seismicity vs. performing the analysis on all boxes in the analysis region. Note that each of these techniques may yield a different value for Fₘₐₓ.

### Earthquake Forecast Environment

FIG. 10 illustrates an earthquake forecast environment 1000 in accordance with an embodiment of the present invention. Earthquake forecast environment 1000 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 10, earthquake forecast environment 1000 includes clients 1010-1012, users 1020 and 1021, servers 1030-1050, network 1060, and an earthquake database 1070.

Clients 1010-1012 can include any node on a network including computational capability and including a mechanism for communicating across the network. Note that clients 1010-1012 can send requests to servers 1030-1050 to execute computer programs written to perform the RIPI technique for earthquake forecast.

Similarly, servers 1030-1050 can generally include any node on a network including a mechanism for servicing requests from a client for computational and/or data storage resources. In one embodiment of the present invention, servers 1030-1050 are supercomputers. Note that servers 1030-1050 can execute computer programs written to perform the RIPI technique for earthquake forecast in response to the requests from servers 1030-1050.

Users 1020 and 1021 can include: an individual; a group of individuals; an organization; a group of organizations; a computing system; a group of computing systems; or any other entity that can interact with earthquake forecast environment 1000.

Network 1060 can include any type of wired or wireless communication channel capable of coupling together computing nodes. This includes, but is not limited t₀, a local area network, a wide area network, or a combination of networks. In one embodiment of the present invention, network 1060 includes the Internet.

Earthquake database 1070 can include any type of system for storing seismicity events data in non-volatile storage. This includes, but is not limited t₀, systems based upon magnetic, optical, or magneto-optical storage devices, as well as storage devices based on flash memory and/or battery-backed up memory. Note that earthquake database 1070 can be coupled to a server (such as server 1050) or directly to network 1060. Note that earthquake database 1070 can be Advanced National Seismic System (ANSS), or Southern California Earthquake Data Center (SCEDC), or Northern California Earthquake Data Center (NCEDC).

Note that different embodiments of the present invention may use different configurations, and are not limited to the configuration illustrated in earthquake forecast environment 1000.

In one embodiment of the present invention, the computer program for earthquake forecasting may use a structure which allows it to run efficiently over arbitrarily large scales.

In one embodiment of the present invention, the above computer program execution is scriptable so that no user intervention is required once the parameters are determined.

In one embodiment of the present invention, computer scripts are used to automatically download and update seismicity data from web repositories and convert it to the format used by the analysis.

In one embodiment of the present invention, the computer program for earthquake forecasting is written to run on a single computer or a cluster of high-performance computers. More computers will further reduce this time.

In one embodiment of the present invention, earthquake forecast outputs may be in XML format. This facilitates data archiving, searching, and delivery via the Internet.

### SUMMARY

The following itemized procedure constitutes one embodiment of the present invention which uses the RIPI technique for earthquake forecasting.
1. Partition a seismically active region into a set of boxes of predetermined size, and use all events having m≧m_{C}. These boxes are labeled as xᵢ.
2. Obtain seismicity data from the regional catalog for each day in each pixel box. This seismicity data may be considered as uniformly spread over each box. The resulting seismicity intensities for each box form a time series.
3. Determine the three time parameters t₀,t₁, and t₂. Specifically, to is chosen to be the initial time of event counting. In the example of California, one can take t₀=1 Jan. 1932. In one embodiment of the present invention, t₂ is chosen such that the number of m>m_{T} events during the time period t₂→t is equal to some value specified by the regional b-value. t₁ is chosen such that t₂−t₁=Δt.
4. Create an RI map I(xᵢ;t₀,t₂), and a PI map ΔI(xᵢ;t₀,t₁,t₂) for the region.
5. Convert RI and PI maps into binary forecast maps, and construct ROC diagrams for the test interval t₂→t.
6. Compute ΔA(t) by integrating A_{RI}(t)−A_{PI}(t) over Fε[0, Fₘₐₓ].
7. Average ΔA(t) for a range of test intervals to obtain the final risk classifier ΔA(t).
8. Determine risk: if ΔA(t)>0, a warning is issued that future large earthquakes are likely to occur; if ΔA(t)<0, no such warning is issued.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

TABLE 1
Dates, locations, and magnitudes of earthquakes
with m ≧ 6.0 since 1960 in California

| Date | Latitude | Longitude | Mag |
|---|---|---|---|
| 9 Apr. 1968 | 33.1900° N | 116.129° W | 6.5 |
| 9 Feb. 1971 | 34.4112° N | 118.401° W | 6.6 |
| 15 Oct. 1979 | 32.6137° N | 115.318° W | 6.4 |
| 25 May 1980 | 37.5905° N | 118.833° W | 6.1 |
| 25 May 1980 | 37.6673° N | 118.918° W | 6.0 |
| 25 May 1980 | 37.5185° N | 118.820° W | 6.1 |
| 27 May 1980 | 37.5002° N | 118.808° W | 6.2 |
| 2 May 1983 | 36.2277° N | 120.318° W | 6.0 |
| 24 Apr. 1984 | 37.3097° N | 121.679° W | 6.2 |
| 21 Jul. 1986 | 37.5387° N | 118.443° W | 6.4 |
| 24 Nov. 1987 | 33.0900° N | 115.792° W | 6.2 |
| 24 Nov. 1987 | 33.0150° N | 115.852° W | 6.6 |
| 18 Oct. 1989 | 37.0362° N | 121.880° W | 7.0 |
| 23 Apr. 1992 | 33.9600° N | 116.317° W | 6.1 |
| 28 Jun. 1992 | 34.2000° N | 116.437° W | 7.3 |
| 28 Jun. 1992 | 34.2030° N | 116.827° W | 6.3 |
| 17 May 1993 | 37.1763° N | 117.832° W | 6.1 |
| 17 Jan. 1994 | 34.2130° N | 118.537° W | 6.7 |
| 16 Oct. 1999 | 34.5940° N | 116.271° W | 7.1 |
| 22 Dec. 2003 | 35.7002° N | 121.097° W | 6.5 |
| 28 Sep. 2004 | 35.8182° N | 120.366° W | 6.0 |

1. A method for forecasting earthquakes, comprising:
generating a relative intensity (RI) map of a geographic region, wherein the RI map represents a normalized intensity in seismic activity over the geographic region during a time period from t₀ to t₂ (t₀<t₂);
generating a pattern informatics (PI) map of the geographic region, wherein the PI map represents a time-averaged change in the normalized intensity in seismic activity during a change interval from t₁ to t₂ (t₁<t₂);
comparing the PI map against the RI map; and
forecasting an earthquake with a magnitude greater than m within the geographic region based on the comparison between the PI map and the RI map.

2. The method of claim 1, wherein prior to generating the RI map and the PI map, the method further comprises partitioning the geographic region into a mesh of pixel boxes based on the forecast magnitude m.

3. The method of claim 2, wherein generating the RI map of the geographic region involves:
for each pixel box xᵢ, obtaining a number of earthquakes n(xᵢ; t₀, t₂) having magnitude values greater than a cutoff magnitude m_{C} which occur within the pixel box between t₀ and t₂;
computing a total number of earthquakes which occur between t₀ and t₂ by summing the number of earthquakes greater than m_{C} over all the pixel boxes; and
computing a normalized intensity I(xᵢ; t₀, t₂) by dividing the number of earthquakes n(xᵢ; t₀, t₂) by the total number of earthquakes.

4. The method of claim 3, wherein generating the PI map of the geographic region involves:
obtaining a number of earthquakes n(xᵢ; t_{b}, t₂) having magnitude values greater than the cutoff magnitude m_{C} which occur within each pixel box xᵢ between t_{b} and t₂; and
obtaining a number of earthquakes n(xᵢ; t_{b}, t₁) having magnitude values greater than the cutoff magnitude m_{C} which occur within each pixel box xᵢ between t_{b} and t₁ wherein t₂>t₁>t_{b}.

5. The method of claim 4, wherein generating the PI map of the geographic region involves:
computing rates of the earthquakes S(xᵢ; t_{b}, t₂) and S(xᵢ; t_{b}, t₁) by dividing n(xᵢ; t_{b}, t₂) and n(xᵢ; t_{b}, t₁) by (t₂−t_{b}) and (t₁−t_{b}), respectively;
obtaining time-averaged changes S(xᵢ;t₀,t₂) and S(xᵢ;t₀,t₁) by averaging S(xᵢ,t_{b},t₂) and S(xᵢ,t_{b},t₁) over all values t_{b} in the ranges t₀≦t_{b}<t₂ and t₀≦t_{b}<t₁, respectively; and
obtaining normalized intensity S̅(xᵢ;t₀,t₂) and S̅(xᵢ;t₀,t₁) having zero means and unit variances by computing the spatial means and standard deviations of Ŝ(xᵢ;t₀,t₂) and Ŝ(xᵢ;t₀,t₁) and normalizing Ŝ(xᵢ;t₀,t₂) and Ŝ(xᵢ;t₀,t₁) by subtracting the respective means and dividing by the respective standard deviations.

6. The method of claim 5, wherein generating the PI map of the geographic region involves:
computing a change in the normalized intensity Δ S̅(xᵢ;t₀,t₁,t₂) from t₁ to t₂ using Δ S̅(xᵢ;t₀,t₁,t₂)= S̅(xᵢ;t₀,t₂)− S̅(xᵢ;t₀,t₁);
computing the square value Δ S̅²(xᵢ;t₀,t₁,t₂); and
normalizing Δ S̅² (xᵢ;t₀,t₁,t₂) over the geographic region to obtain the PI map ΔI(xᵢ;t₀,t₁,t₂) so that the integral of the PI map ΔI(xᵢ;t₀,t₁,t₂) over the geographic region is equal to 1.

7. The method of claim 6, wherein the method further comprises choosing t₂ such that a number of greater than forecast magnitude m earthquakes occurred within a test interval [t₂,t_{C}] is substantially equal to a predetermined number M, wherein t_{C} is a current time.

8. The method of claim 7, wherein the method further comprises choosing t₁ based on the chosen t₂.

9. The method of claim 8, wherein comparing the PI map against the RI map involves:
predicting one or more earthquakes with a magnitude greater than forecast magnitude m using the RI map and the PI map respectively; and
comparing the predictions of the RI map and the PI map.

10. The method of claim 9, wherein predicting the earthquakes using the RI map or the PI map involves:
choosing an evaluation time window [t_{A},t_{B}] during which N earthquakes with magnitude greater than forecast magnitude m are recorded; and
computing a respective probability distribution over the evaluation time window for the geographic region for the RI map or the PI map, so that each pixel box in the probability distribution is associated with a probability value of recording an earthquake of magnitude greater than forecast magnitude m during the evaluation time window.

11. The method of claim 10, wherein computing the probability distributions over the evaluation time window for the geographic region for the RI map or the PI map involves converting the RI map and the PI maps into respective binary forecast maps.

12. The method of claim 11, wherein converting the RI map and the PI maps into respective binary forecast maps involves:
receiving a threshold value D, wherein 0≦D≦1;
for each pixel box xᵢ in the RI map and the PI map,
comparing the respective value of the RI map and the PI map at pixel box xᵢ against D;
if the respective value of the RI map and the PI map is greater than D, producing a binary value B(xᵢ)=1 for the pixel box xᵢ; and
otherwise, producing a binary value B(xᵢ)=0 for the pixel box xᵢ.

13. The method of claim 12, wherein the evaluation time window [t_{A}, t_{B}] is the test interval [t₂,t_{C}].

14. The method of claim 13, wherein comparing the predictions of the RI map and PI map involves:
building a respective ROC curve for the RI map and the PI map for a given current time t_{C};
computing a difference function by subtracting the ROC curve for the PI map from the ROC curve for the RI map; and
obtaining a difference ΔA in the predictions by integrating an area under the difference function over the ROC domain.

15. The method of claim 14, wherein the method further comprises constructing a risk classifier ΔA(t_{C}) while varying the current time t_{C}.

16. The method of claim 15, wherein building the respective ROC curve for the RI map and the PI map involves:
determining a subset of N pixel boxes x_{q}(m) within the geographic region wherein greater than forecast magnitude m earthquakes are recorded during the evaluation time window; and
for each threshold value D,
converting the RI map and the PI map into a respective binary forecast map; and
computing a respective hit rate and a respective false alarm rate based on the respective binary forecast map associated with D and the N pixel locations x_{q}(m),
whereby building the respective ROC curves for the RI map and the PI map by varying the threshold value D.

17. The method of claim 16, wherein computing the hit rate and the false alarm rate involves constructing a contingency table based on the binary forecast map associated with D and the N pixel locations x_{q}(m).

18. The method of claim 15, wherein forecasting an earthquake with a magnitude greater than m based on the comparison between the PI map and the RI map involves forecasting if the geographic region is currently in a high-risk time period for an earthquake with a magnitude greater than m.

19. The method of claim 18, wherein forecasting if the geographic region is currently in a high-risk time period involves determining if the risk classifier ΔA(t_{C})>0 at a current time t_{C}.

20. The method of claim 18, wherein the method further comprises determining that the geographic region is currently in a low-risk time period when the risk classifier ΔA(t_{C})<0 at a current time t_{C}.

21. The method of claim 18, wherein the method further comprises identifying an onset time of a high-risk time period when the risk classifier transitions from ΔA(t_{C})<0 to ΔA(t_{C})>0.

22. The method of claim 21, wherein the method further comprises determining a probability of an occurrence of an earthquake with a magnitude greater than m based on an elapsed time from the onset time of a high-risk time period and a Weibull distribution.

23. The method of claim 1, wherein forecasting the earthquake within the geographic region involves forecasting locations and a time window for the earthquake.

24. The method of claim 2, wherein partitioning the geographic region into a mesh of pixel boxes based on the given magnitude m involves using a larger pixel box for a higher forecast magnitude m.

25. The method of claim 10, wherein choosing the evaluation time window [t_{A},t_{B}] involves choosing a longer time window for a higher forecast magnitude m.

26. A computer-readable storage medium storing instructions that when executed by a computer cause the computer to perform a method for forecasting earthquakes, the method comprising:
generating a relative intensity (RI) map of a geographic region, wherein the RI map represents a normalized intensity in seismic activity over the geographic region during a time period from t₀ to t₂ (t₀<t₂);
generating a pattern informatics (PI) map of the geographic region, wherein the PI map represents a time-averaged change in the normalized intensity in seismic activity during a change interval from t₁ to t₂ (t₁<t₂);
comparing the PI map against the RI map; and
forecasting an earthquake with a magnitude greater than m within the geographic region based on the comparison between the PI map and the RI map.

27. The computer-readable storage medium of claim 26, wherein prior to generating the RI map and the PI map, the method further comprises partitioning the geographic region into a mesh of pixel boxes based on the forecast magnitude m.

28. The computer-readable storage medium of claim 27, wherein generating the RI map of the geographic region involves:
for each pixel box xᵢ, obtaining a number of earthquakes n(xᵢ;t₀,t₂) having magnitude values greater than a cutoff magnitude m_{C} which occur within the pixel box between t₀ and t₂;
computing a total number of earthquakes which occur between t₀ and t₂ by summing the number of earthquakes greater than m_{C} over all the pixel boxes; and
computing a normalized intensity I(xᵢ;t₀,t₂) by dividing the number of earthquakes n(xᵢ;t₀,t₂) by the total number of earthquakes.

29. The computer-readable storage medium of claim 28, wherein generating the PI map of the geographic region involves:
obtaining a number of earthquakes n(xᵢ;t_{b},t₂) having magnitude values greater than the cutoff magnitude m_{C} which occur within each pixel box xᵢ between t_{b} and t₂; and
obtaining a number of earthquakes n(xᵢ;t_{b},t₁) having magnitude values greater than the cutoff magnitude m_{C} which occur within each pixel box xᵢ between t_{b} and t₁, wherein t₂>t₁>t_{b}.

30. The computer-readable storage medium of claim 29, wherein generating the PI map of the geographic region involves:
computing rates of the earthquakes S(xᵢ,t_{b},t₂) and S(xᵢ,t_{b},t₁) by dividing n(xᵢ;t_{b},t₂) and n(xᵢ;t_{b},t₁) by (t₂−t_{b}) and (t₁−t_{b}), respectively;
obtaining time-averaged changes Ŝ(xᵢ;t₀,t₂) and Ŝ(xᵢ;t₀,t₁) by averaging S(xᵢ,t_{b},t₂) and S(xᵢ,t_{b},t₁) over all values t_{b} in the ranges t₀≦t_{b}<t₂ and t₀≦t_{b}<t₁, respectively; and
obtaining normalized intensity S̅(xᵢ;t₀,t₂) and S̅(xᵢ;t₀,t₁) having zero means and unit variances by computing the spatial means and standard deviations of Ŝ(xᵢ;t₀,t₂) and Ŝ(xᵢ;t₀,t₁) and normalizing Ŝ(xᵢ;t₀,t₂) and Ŝ(xᵢ;t₀,t₁) by subtracting the respective means and dividing by the respective standard deviations.

31. The computer-readable storage medium of claim 30, wherein generating the PI map of the geographic region involves:
computing a change in the normalized intensity Δ S̅(xᵢ;t₀,t₁,t₂) from t₁ to t₂ using Δ S̅(xᵢ;t₀,t₁,t₂)= S̅(xᵢ;t₀,t₂)− S̅(xᵢ;t₀,t₁);
computing the square value Δ S̅²(xᵢ;t₀,t₁,t₂); and
normalizing Δ S̅²(xᵢ;t₀,t₁,t₂) over the geographic region to obtain the PI map ΔI(xᵢ;t₀,t₁,t₂) so that the integral of the PI map ΔI(xᵢ;t₀,t₁,t₂) over the geographic region is equal to 1.

32. The computer-readable storage medium of claim 31, wherein the method further comprises choosing t₂ such that a number of greater than forecast magnitude m earthquakes occurred within a test interval [t₂,t_{C}] is substantially equal to a predetermined number M, wherein t_{C} is a current time.

33. The computer-readable storage medium of claim 32, wherein the method further comprises choosing t₁ based on the chosen t₂.

34. The computer-readable storage medium of claim 33, wherein comparing the PI map against the RI map involves:
predicting one or more earthquakes with a magnitude greater than forecast magnitude m using the RI map and the PI map respectively; and
comparing the predictions of the RI map and the PI map.

35. The computer-readable storage medium of claim 34, wherein predicting the earthquakes using the RI map or the PI map involves:
choosing an evaluation time window [t_{A},t_{B}] during which N earthquakes with magnitude greater than forecast magnitude m are recorded; and
computing a respective probability distribution over the evaluation time window for the geographic region for the RI map or the PI map, so that each pixel box in the probability distribution is associated with a probability value of recording an earthquake of magnitude greater than forecast magnitude m during the evaluation time window.

36. The computer-readable storage medium of claim 35, wherein computing the probability distributions over the evaluation time window for the geographic region for the RI map or the PI map involves converting the RI map and the PI map into respective binary forecast maps.

37. The computer-readable storage medium of claim 36, wherein converting the RI map and the PI maps into respective binary forecast maps involves:
receiving a threshold value D, wherein 0≦D≦1;
for each pixel box xᵢ in the RI map and the PI map,
comparing the respective value of the RI map and the PI map at pixel box xᵢ against D;
if the respective value of the RI map and the PI map is greater than D, producing a binary value B(xᵢ)=1 for the pixel box xᵢ; and
otherwise, producing a binary value B(xᵢ)=0 for the pixel box xᵢ.

38. The computer-readable storage medium of claim 37, wherein the evaluation time window [t_{A},t_{B}] is the test interval [t₂,t_{C}].

39. The computer-readable storage medium of claim 38, wherein comparing the predictions of the RI map and the PI map involves:
building a respective ROC curve for the RI map and the PI map for a given current time t_{C};
computing a difference function by subtracting the ROC curve for the PI map from the ROC curve for the RI map; and
obtaining a difference ΔA in the predictions by integrating an area under the difference function over the ROC domain.

40. The computer-readable storage medium of claim 39, wherein the method further comprises constructing a risk classifier ΔA (t_{C}) while varying the current time t_{C}.

41. The computer-readable storage medium of claim 40, wherein building the respective ROC curve for the RI map and the PI map involves:
determining a subset of N pixel boxes x_{q}(m) within the geographic region wherein greater than forecast magnitude m earthquakes are recorded during the evaluation time window; and
for each threshold value D,
converting the RI map and the PI map into a respective binary forecast map; and
computing a respective hit rate and a respective false alarm rate based on the respective binary forecast map associated with D and the N pixel locations x_{q}(m),
whereby building the respective ROC curves for the RI map and the PI map by varying the threshold value D.

42. The computer-readable storage medium of claim 41, wherein computing the hit rate and the false alarm rate involves constructing a contingency table based on the binary forecast map associated with D and the N pixel locations x_{q}(m).

43. The computer-readable storage medium of claim 40, wherein forecasting an earthquake with a magnitude greater than m based on the comparison between the PI map and the RI map involves forecasting if the geographic region is currently in a high-risk time period for an earthquake with a magnitude greater than m.

44. The computer-readable storage medium of claim 43, wherein forecasting if the geographic region is currently in a high-risk time period involves determining if the risk classifier ΔA(t_{C})>0 at a current time t_{C}.

45. The computer-readable storage medium of claim 43, wherein the method further comprises determining that the geographic region is currently in a low-risk time period when the risk classifier ΔA(t_{C})<0 at a current time t_{C}.

46. The computer-readable storage medium of claim 43, wherein the method further comprises identifying an onset time of a high-risk time period when the risk classifier transitions from ΔA(t_{C})<0 to ΔA(t_{C})>0.

47. The computer-readable storage medium of claim 46, wherein the method further comprises determining a probability of an occurrence of an earthquake with a magnitude greater than m based on an elapsed time from the onset time of a high-risk time period and a Weibull distribution.

48. The computer-readable storage medium of claim 26, wherein forecasting the earthquake within the geographic region involves forecasting locations and a time window for the earthquake.

49. The computer-readable storage medium of claim 27, wherein partitioning the geographic region into a mesh of pixel boxes based on the given magnitude m involves using a larger pixel box for a higher forecast magnitude m.

50. The computer-readable storage medium of claim 35, wherein choosing the evaluation time window [t_{A},t_{B}] involves choosing a longer time window for a higher forecast magnitude m.

51. A system that forecasts earthquakes, comprising:
a server;
an earthquake database coupled to the server;
wherein the server is configured to:
generate a relative intensity (RI) map of a geographic region, wherein the RI map represents a normalized intensity in seismic activity over the geographic region during a time period from t₀ to t₂ (t₀<t₂);
generate a pattern informatics (PI) map of the geographic region, wherein the PI map represents a time-averaged change in the normalized intensity in seismic activity during a change interval from t₁ to t₂ (t₁<t₂);
compare the PI map against the RI map; and
forecast an earthquake with a magnitude greater than m within the geographic region based on the comparison between the PI map and the RI map.
